(19) United States
(12) Patent Application Publication
(10) Pub. No.: US 2010/0062174 A1
(43) Pub. Date: Mar. 11, 2010

(54) Method for producing resin structure

(75) Inventors: Kazuhiro Shiojiri, Minami-Ashigara-shi (JP); Kazuhiro Oki, Minami-Ashigara-shi (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/585,032

(22) Filed: Sep. 1, 2009

(30) Foreign Application Priority Data
Sep. 5, 2008 (JP) 2008-228287

(51) Int. Cl. C08F 2/48

(52) U.S. Cl. 427/508

(57) ABSTRACT

A method for producing with high productivity a resin structure which can be used in an optical control film is provided. The method for producing a resin structure includes: applying with a coating applicator, a coating liquid in which at least one polyfunctional monomer or polyfunctional oligomer and a polymerization initiator are dissolved to a traveling support; and irradiating the coating liquid with ultraviolet rays, with an ultraviolet irradiation apparatus, to cure the coating liquid by polymerization to form a columnar structure.

### BACKGROUND OF THE INVENTION

1. Field of the Invention

The present invention relates to a method for producing a resin structure, particularly to a method for producing a resin structure having optical properties such as light diffusion and diffraction.

2. Description of the Related Art

Attempts have been made to form on a substrate a resin structure having anisotropy on the order of a submicron to a micron order for use in electronic materials, optical materials, and the like.

For example, Japanese Patent Application Laid-Open No. 63-309902 proposes a method for irradiating a resin composition having a plurality of polymerizable carbon-carbon double bonds with ultraviolet rays of a line light source to cure the resin composition into a film, thereby forming a layered structure for use as an optical control film.

Japanese Patent Application Laid-Open No. 2005-242340 describes a method for producing a molded body having a columnar structure by irradiating a monomer or an oligomer with parallel ultraviolet rays.

Japanese Patent Application Laid-Open No. 2005-265915 describes a method for irradiating a photopolymerizable compound selected from a polymer, an oligomer, and a monomer with ultraviolet rays or the like from a point light source, thereby forming a bell-shaped curved surface within a film to improve the anisotropy.

Japanese National Publication of International Patent Application No. 11-500544 describes a method for forming a waveguide by previously forming grooves in a substrate, applying a photocrosslinkable monomer mixture to the substrate, and irradiating the mixture with light from a surface opposite to the surface on which the grooves are formed.

Japanese Patent Application Laid-Open No. 2005-219144 describes a method for forming a structure corresponding to a mask pattern by exposure to ultraviolet rays through the mask pattern.

Japanese Patent Application Laid-Open No. 2003-94825 describes a method for utilizing a microphase-separated structure composed of a block copolymer as a method for forming a columnar structure.

### SUMMARY OF THE INVENTION

However, although a film produced by the method of Japanese Patent Application Laid-Open No. 63-309902 has sufficient anisotropy to the light from a specific angle, the film has insufficient anisotropy to the light incident from various angles.

Further, a problem of the method of Japanese Patent Application Laid-Open No. 2005-242340 is its low productivity because a monomer or an oligomer needs to be injected into the molding body before it is exposed to parallel light incident. Similarly, a problem of the method of Japanese Patent Application Laid-Open No. 2005-265915 is its low productivity because it is necessary to apply a monomer or an oligomer to a substrate and then laminate a glass plate thereto before the monomer or the oligomer is cured, and it is necessary to use a spacer or the like to obtain a constant film thickness at the lamination of the glass plate.

A problem of the method of Japanese National Publication of International Patent Application No. 11-500544 is its low productivity because the step of forming a structure in a substrate is further required.

In the method of Japanese Patent Application Laid-Open No. 2005-219144, a precision on the order of a micron or less is required for the mask. Another problem is that a columnar structure cannot be continuously produced.

A problem of the method of Japanese Patent Application Laid-Open No. 2003-94825 is that the method cannot form a structure on the order of a submicron or less and the resulting structure cannot be used in general optical applications.

The present invention has been made in view of the above circumstances, and an object of the present invention is to provide a method for producing a resin structure with high productivity which is suitable for producing a resin structure which can be used for an optical control film.

In order to achieve the object, according to a first aspect of the present invention, a method for producing a resin structure comprises the steps of: applying a coating liquid in which at least one polyfunctional monomer or polyfunctional oligomer and a polymerization initiator are dissolved to a traveling support; and irradiating the coating liquid with parallel active energy rays to cure the coating liquid by polymerization reaction to form a columnar structure.

According to the first aspect of the present invention, a columnar structure is formed by applying a coating liquid in which at least one monomer or oligomer and a polymerization initiator are dissolved to a traveling support, and then polymerizing the coating liquid with parallel active energy rays. Therefore, the resin structure can be produced with high productivity. Further, it is possible to easily cure the coating liquid into a columnar structure by polymerization reaction by using a polyfunctional monomer or a polyfunctional oligomer as a monomer or an oligomer, respectively.

Furthermore, since the coating liquid is fed to the support by a coating method, the thickness of the coating layer can be made constant without using a spacer or the like.

Here, a polyfunctional monomer or a polyfunctional oligomer means a monomer or an oligomer having a plurality of carbon-carbon double bonds in a molecule.

In the method for producing a resin structure according to the first aspect of the present invention, the step of irradiating the coating liquid with parallel active energy rays to cure the coating liquid by polymerization reaction to form a columnar structure is preferably performed under an atmosphere having an oxygen concentration of 21% or less, more preferably 100 ppm or less.

Since the oxygen concentration is controlled in the above-mentioned range, the active energy rays are not used for forming oxygen radicals but are used for polymerization reaction. Therefore, the efficiency of the active energy rays is improved to improve productivity.

A low oxygen concentration can also prevent inhibition of polymerization by oxygen radicals.

As described above, according to the present invention, a resin structure which can be used in an optical control film can be produced with high productivity.

### BRIEF DESCRIPTION OF THE DRAWINGS

FIG. 1 is a schematic diagram showing an example of the structure of a resin structure; and

FIG. 2 is a schematic diagram showing an example of a method for producing a resin structure according to an embodiment.

### DETAILED DESCRIPTION OF THE PREFERRED EMBODIMENTS

Preferred embodiments of the present invention will be described below according to accompanying drawings. Although the present invention is described by the following preferred embodiments, modifications can be made with many procedures without departing from the scope of the present invention, and embodiments other than the present embodiments can also be used. Therefore, all the modifications within the scope of the present invention are included in the claims.

The numerical value range represented by using “X to Y” in the present specification means a range including the numerical values X and Y.

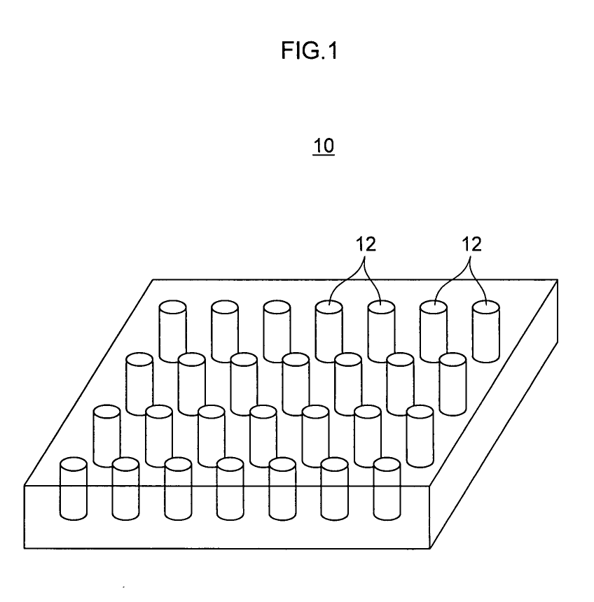

FIG. 1 is a schematic diagram showing the structure of a resin structure according to the present invention. As shown in FIG. 1, a resin structure 10 includes a plurality of columnar structures 12 within the resin structure. The columnar structure 12 has a refractive index different from that of other portions. Each of the columnar structures 12 has a shape extending in the thickness direction so that its axis substantially coincide with an irradiation direction of active energy rays, and further, the columnar structures 12 are arranged regularly. The columnar structures 12 in FIG. 1 each have a cylindrical shape having a size of 2 to 8 μm.

The resin structure 10 shown in FIG. 1 includes columnar structures 12 each having a refractive index different from that of other portions. Thus, it can be used as an optical control film having optical properties such as light diffusion, diffraction, and polarization. The columnar structure 12 has a refractive index of preferably 1.40 to 1.70, more preferably 1.45 to 1.60.

Further, the refractive index difference between the columnar structures 12 and other portions is preferably 0.01 to 0.20, more preferably 0.10 to 0.20.

A columnar structure on the order of a micron works as a diffraction grating for light and changes the luminance distribution of linear light. Further, the reflection at the interface between different refractive indices similarly causes a change in luminance distribution and provides a light diffusing effect.

In order to produce a resin structure of the present invention, there is used a coating liquid in which at least one polyfunctional monomer or polyfunctional oligomer and a polymerization initiator are dissolved.

Polyfunctional monomers having a plurality of functional groups (carbon-carbon double bonds) which can be used include polyethylene glycol diacrylate, dipropylene glycol diacrylate, a modified bisphenol A diacrylate, 1,6-hexanediol diacrylate, 1,9-nonanediol diacrylate, neopentyl glycol diacrylate, tripropylene glycol diacrylate, and tricyclodecane dimethanol diacrylate. Mixtures of these compounds can also be used.

Particularly, polyfunctional monomers having three or more functional groups which can be used include trimethylolpropane triacrylate, tetramethylolmethane tetraacrylate, dipentaerythritol hexaacrylate, pentaerythritol tetraacrylate, and trimethylolpropane ethoxy triacrylate. Polyfunctional monomers having a larger number of functional groups more easily undergo polymerization reaction, so these monomers are suitable for forming a columnar structure.

The polymerization initiator dissolved in a coating liquid of the present invention is not particularly limited, as long as it is a polymerization initiator used in the conventional photopolymerization in which the polymerization is performed by irradiation with active energy rays such as ultraviolet rays. Examples of the polymerization initiators which can be used include benzophenone, benzil, 2-chloro thioxanthone, benzoin ethyl ether, 1-hydroxy-cyclohexyl phenyl ketone, 2-hydroxy-2-methyl-1-phenyl-propan-1-one, 2-benzyl-2-dimethylamino-1-(4-morpholinophenyl)-butanone-1, and 2-methyl-1-(4-methylthiophenyl)-2-morpholinopropan-1-one.

The ratio of the polyfunctional monomer or the polyfunctional oligomer to the polymerization initiator is preferably 100:0.01 to 100:5 in order to maintain the transparency of a molded body.

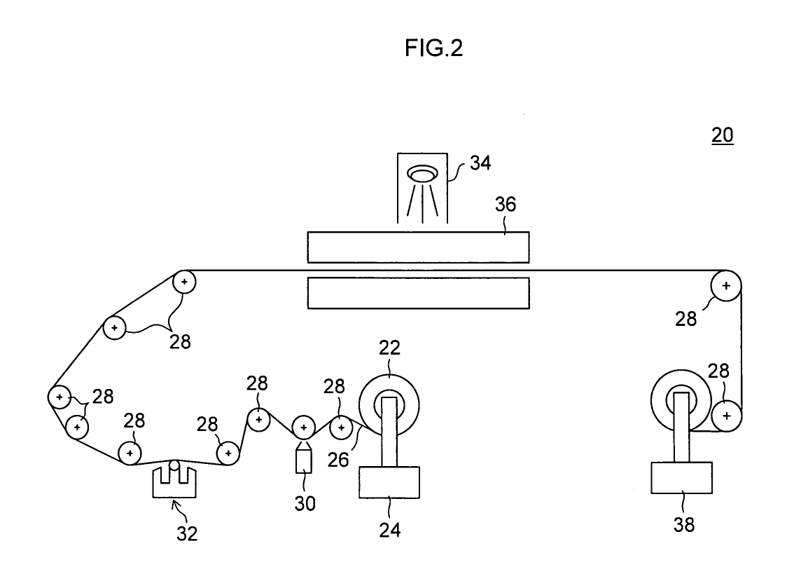

Next, the method for producing a resin structure according to the present invention will be described with reference to FIG. 2. FIG. 2 is an entire block diagram showing an example of a production line 20 for implementing the production method of the present invention.

A long support 26 (including a support on which a certain functional layer is already formed) is fed from a film roll 22 by a feeder 24. The traveling speed of the support 26 can be, for example, in the range of 0.1 to 1.5 m/s.

The support 26 has a transmittance of preferably 80% or more, more preferably 90% or more. The support 26 has a haze of preferably 2.0% or less, more preferably 1.0% or less. The support 26 preferably has a refractive index of 1.4 to 1.6. Further, it is preferred to use a plastic film. Examples of the materials of plastic films include cellulose ester, polyamide, polycarbonate, polyester (such as polyethylene terephthalate and polyethylene naphthalate), polystyrene, polyolefin, polysulfone, polyethersulfone, polyarylate, polyetherimide, polymethylmethacrylate, and polyetherketone.

The support 26 is guided by a guide roller 28 and is sent into a dust remover 30. The dust remover 30 can remove the dust adhering to the surface of the support 26. A coating applicator 32 having an extrusion-type coating head which is an application device is provided downstream of the dust remover 30. A coating liquid in which at least one polyfunctional monomer or polyfunctional oligomer and a polymerization initiator are dissolved is applied to the support 26 wound around a backup roller by the coating applicator 32. The thickness of the coating liquid may be, for example, 500 μm or less.

Examples of coating methods which can be used include a dip coating method, an air knife coating method, a curtain coating method, a slide coating-method, a roller coating method, a wire bar coating method, a gravure coating method, and a microgravure method.

An ultraviolet irradiation apparatus 34 is provided downstream of the coating applicator 32 in order to irradiate the coating liquid applied to the support 26 with active energy rays (for example, ultraviolet rays). A polymerization reaction occurs in the coating liquid by irradiating with ultraviolet rays from the ultraviolet irradiation apparatus 34. Curing and crosslinking proceed by the polymerization reaction to form desired columnar structures.

In the present embodiment, below the ultraviolet irradiation apparatus 34 is provided an irradiation zone 36 which has an entrance and exit for the support 26 and surrounds the support 26. The irradiation zone 36 is formed with a material which can transmit the active energy rays to be irradiated.

When irradiating with ultraviolet rays, the atmosphere in the irradiation zone 36 is adjusted so that the oxygen concentration is 21% or less, preferably 100 ppm or less. Since the oxygen concentration is controlled in the above-mentioned range, the active energy rays are not used for forming oxygen radicals but are used for polymerization reaction. Accordingly, the efficiency of the active energy rays is improved to improve productivity. Further, it is also possible to prevent inhibition of polymerization by oxygen radicals.

As a method of adjusting oxygen concentration within the above-mentioned range, a method of purging nitrogen gas into the irradiation zone 36 and so on can be adopted.

A winding machine 38 for winding the support 26 in which a columnar structure has been formed is provided downstream of the irradiation zone 36.

### EXAMPLES

The present invention will be described more specifically below with reference to Examples. Materials, production conditions, and the like shown in the following Examples can be appropriately modified as long as they do not depart from the spirit of the present invention. Therefore, the scope of the present invention is not limited to the following specific examples.

The coating liquids shown below were prepared and respectively applied to triacetyl cellulose films having a thickness of 80 μm (Fujitac from Fujifilm Corporation) to have a thickness of 250 μm. After the coating, the film was irradiated with ultraviolet rays using a parallel light ultraviolet irradiation apparatus provided with an ultrahigh pressure mercury lamp.

### Example 1

In 100 parts by mass of pentaerythritol triacrylate as a photopolymerizable monomer was dissolved one part by mass of 2-benzyl-2-dimethylamino-1-(4-morpholinophenyl)-butanone-1 to obtain a photopolymerizable composition as a coating liquid. The resulting photopolymerizable composition was irradiated with ultraviolet rays in an environment having an oxygen concentration of 90 ppm to form a coating layer. The film thus obtained was cut to a predetermined size and evaluated for the presence of a columnar structure and the surface stickiness.

The surface of the columnar structure was observed using an optical microscope. The symbol “B” denotes the case where the structure was found on the whole surface; the symbol “C” denotes the case where the structure was found in 80% or more of the whole; and the symbol “D” denotes the case where the structure was hardly or not found. The internal cross-section of the columnar structure was similarly observed using an optical microscope. The symbol “B” denotes the case where the structure had grown to 80% or more of a thickness of the coating layer; the symbol “C” denotes the case where the structure had grown to 50% or more and less than 80% of the thickness of the coating layer; and the symbol “D” denotes the case where the structure had grown to less than 50% or the case where the structure was not observed.

The surface stickiness was evaluated by wiping the surface of a sample with a dry cloth. The symbol “A” denotes the case where there was no separation from the sample surface; the symbol “B” denotes the case where only the outmost material within 1 μm from the surface was separated; the symbol “C” denotes the case where the material within 10 μm from the surface was separated; and the symbol “D” denotes the case where the material was separated from the sample surface to such an extent that the support was exposed.

### Example 2

A coating layer was formed in the same manner as in Example 1 except that the photopolymerizable monomer used in Example 1 was replaced by dipentaerythritol hexaacrylate.

### Example 3

A coating layer was formed in the same manner as in Example 1 except that the oxygen concentration when ultraviolet irradiation was performed in Example 1 was changed to 21%.

### Example 4

A coating layer was formed in the same manner as in Example 1 except that the oxygen concentration when ultraviolet irradiation was performed in Example 1 was changed to 150 ppm.

### Example 5

A coating layer was formed in the same manner as in Example 1 except that the photopolymerizable monomer used in Example 1 was replaced by polyethylene glycol diacrylate.

### Comparative Example 1

A coating layer was formed in the same manner as in Example 1 except that the photopolymerizable monomer used in Example 1 was replaced by methyl methacrylate.

Table 1 summarizes the evaluation results for the number of carbon-carbon double bonds, oxygen concentration, the presence of columnar structures, and surface stickiness in Examples 1 to 5 and Comparative Example 1 of the present invention.

TABLE 1

| | Number of | | Columnar | | |
|---|---|---|---|---|---|
| | carbon-carbon | Oxygen | structure | | Surface |
| | double bonds | concentration | Surface | Internal | stickiness |
| Ex. 1 | 3 | 90 ppm | B | B | A |
| Ex. 2 | 6 | 90 ppm | B | B | A |
| Ex. 3 | 3 | 21% | B | C | C |
| Ex. 4 | 3 | 150 ppm | B | C | B |
| Ex. 5 | 2 | 90 ppm | C | B | B |
| Com. | 1 | 90 ppm | D | D | D |
| Ex. 1 | | | | | |

As clearly shown in Table 1, the evaluations for the columnar structure and surface stickiness were C or higher when photopolymerizable monomers having a plurality of carbon-carbon double bonds were used in a coating liquid. In particular, when oxygen concentration was 100 ppm or less, the evaluation for the internal columnar structure was B.

On the other hand, when the number of carbon-carbon double bonds was one in Comparative Example 1, it was found that the columnar structure was not formed even if oxygen concentration was 90 ppm.

What is claimed is:

1. A method for producing a resin structure, comprising the steps of:
applying a coating liquid in which at least one polyfunctional monomer or polyfunctional oligomer and a polymerization initiator are dissolved to a traveling support; and
irradiating the coating liquid with parallel active energy rays to cure the coating liquid by polymerization reaction to form a columnar structure.

2. The method for producing a resin structure according to claim 1, wherein the step of irradiating the coating liquid with parallel active energy rays to cure the coating liquid by polymerization reaction to form a columnar structure is performed under an atmosphere having an oxygen concentration of 21% or less.

3. The method for producing a resin structure according to claim 2, wherein the oxygen concentration is 100 ppm or less.
